(19) United States
(12) Patent Application Publication
(10) Pub. No.: US 2016/0335292 A1
(43) Pub. Date: Nov. 17, 2016

(54) HIERARCHICAL HEAT MAP FOR FAST ITEM ACCESS

(71) Applicant: John P. Tobin, San Jose, CA (US)

(72) Inventor: John P. Tobin, San Jose, CA (US)

(21) Appl. No.: 15/151,355

(22) Filed: May 10, 2016

Related U.S. Application Data
(60) Provisional application No. 62/162,742, filed on May 16, 2015.
(60) Provisional application No. 62/162,656, filed on May 15, 2015.

(51) Int. Cl. G06F 17/30

(52) U.S. Cl. CPC G06F 17/30292; G06F 17/30572

(57) ABSTRACT

Embodiments for creating and using hierarchical data structures. In some embodiments, the hierarchical data structure that organizes user information (e.g., profile, messages, social connections and relationships, videos, photos, and other media) according geo-location. In some embodiments, the hieratical data structure can be used to process queries relating to user request to obtain near real-time photos, video, or other media from other uses located anywhere in the world.

### CROSS-REFERENCES TO RELATED APPLICATIONS

The present application claims priority from and is a nonprovisional application of U.S. Provisional Application No. 62/162,656, entitled “HIERARCHICAL HEAT MAP FOR FAST ITEM ACCESS” filed May 15, 2015, and U.S. Provisional Application No. 62/162,742, entitled “HIERARCHICAL HEAT MAP FOR FAST ITEM ACCESS” filed May 16, 2015, the entire contents of which are herein incorporated by reference for all purposes.

### BRIEF DESCRIPTION OF THE DRAWINGS

FIG. 1 shows an example environment for implementing aspects of embodiments disclosed herein.

FIG. 2 shows an electronic device, according to an embodiment.

FIGS. 3A, 3B, and 3C show a hierarchical cell structure, according to an embodiment.

FIG. 4 shows a process for creating the hierarchically structure of FIGS. 3A, 3B, and 3C, according to an embodiment.

FIG. 5 shows a process for using the hierarchical cell structure of FIGS. 3A, 3B, and 3C to enable users to request near real-time media for anywhere in the world, according to an embodiment.

FIG. 6 is an exemplary environment in which embodiments may be implemented, according to an embodiment.

FIG. 7 illustrates a block diagram of a special-purpose computer, according to an embodiment.

FIGS. 8A, 8B, and 8C show example screenshots, according to an embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details, and that variations and other aspects not explicitly disclosed herein are contemplated within the scope of the various embodiments. Furthermore, well-known features may be omitted or simplified in order not to obscure the embodiment being described.

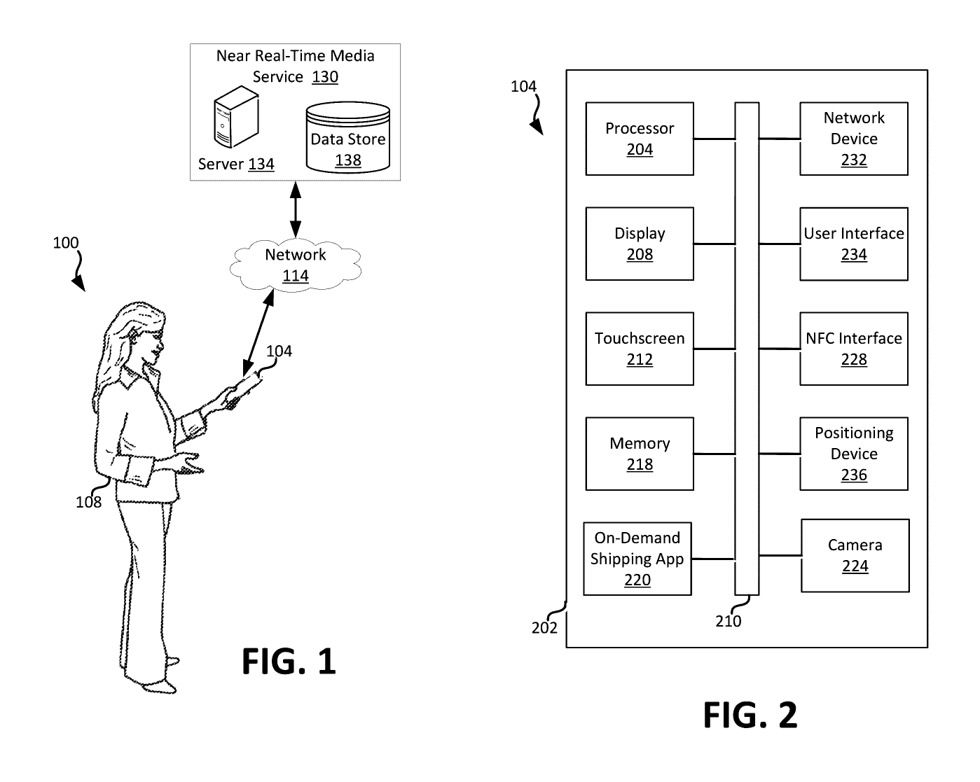

FIG. 1 illustrates an example of an environment 100 for implementing aspects in accordance with various embodiments. As will be appreciated, although environment 100 is provided for purposes of explanation, different environments may be utilized, as appropriate, to implement various embodiments. The illustrated environment 100 includes an electronic device 104, which may include any appropriate device operable to take pictures as well as send and receive requests, messages, photos, video, or other media or information over an appropriate network 114 and convey information back to a user 108 of the electronic device 104. Examples of such electronic devices include mobile phones, electronic devices, mobile devices, handheld messaging devices, laptop computers, personal data assistants, electronic book readers, watches, wrist worn devices and the like.

According to embodiments, the electronic device 104 incorporates the functionality of one or more portable devices, such as a cellular telephone, a media player, a personal computer, etc. Even though the electronic device 104 is portable, a user may use the electronic device 104 to take, save, view, send, receive photo and video, download and execute apps, surf the web, etc. The electronic device 104 may allow a user to connect to and communicate through the network 114, such as the Internet or local or wide area networks. For example, the electronic device 104 may allow a user to communicate using e-mail, text messaging, instant messaging, apps, or other forms of electronic communication.

As illustrated in FIG. 1, the user 108 can use the electronic device 104 to request and receive near real-time images from anywhere in the world. In some embodiments, the user can access an application running on the electronic device 104 to navigate a digital world map to a particular location of interest, and request a picture, video, or other digital media that provides near real-time information about that location. In some embodiments, the world map is heat map that shows relative activity levels across the world, so the user 108 can see which areas are most active, and which have no activity. In some embodiments, the user 108 can navigate and zoom into active areas by selecting shaded areas of the heat map. In some embodiments, the map enables the user 108 to select another user who is active in the relevant area, and send, via the network 114, a message asking that user to take a photo, video or audio recording and send it to the user 108. Thus, enabling the user 108 to obtain near real-time digital media, such as photos or videos, that provides near real-time information about that geographic location. In some embodiments, to respond to the request, the other user accesses an application on his or her own electronic device to take a photo or video with a built-in camera, and send that photo or video to the user 108.

In some embodiments, some or all components, services, and/or aspects of environment can be implemented on the electronic device 104 and/or servers, computers, databases, and other computing devices associated with the near real-time media on demand service 130. The electronic device 104 and the near real-time media on demand service 130 can coordinate to accomplish the processes described herein, and/or each can independent accomplish some or all of the processes described herein. In some embodiments, the near real-time media on demand service 130 is part of a social network that uses location as the exploitable dimension. For example, user locations, rather than user friendships, are used to connect users. For example, the user 108 can communicate with and request photos from a person who is at a location the user 108 is interested in.

FIG. 2 illustrates a block diagram of an example electronic device 104 in accordance with various embodiments. As illustrated, the electronic device 104 includes an external casing 202 that encloses and protects its interior components. The external casing 202 can be made of any suitable material such as plastic, metal, etc. The electronic device 104 may include any number of tactile input controls, including switches, keys, buttons, touch sensitive buttons, etc. The electronic device 104 also includes a display 208 which may display various images generated by the device. The display 208 may be any type of display such as a light-emitting diode (LED) based display, a Retina display, a liquid-crystal display (LCD), etc. The electronic device 104 may include a touch screen 212 that a user can select elements of the display 208 by touching the selected elements.

The display 208 may be used to display a graphical user interface (GUI) that allows a user to interact with the device. The tactile input controls or the touchscreen may be used to navigate the GUI. For example, the icons may be selected by touching the appropriate location of the touch screen 212. When an icon is selected, the electronic device 104 may be configured to open an application associated with that icon and display a corresponding screen. For example, one of the icons is selected associated with, and causes the electronic device 104 to open, a near real-time media on demand application 220. The electronic device 104 may include audio input and output elements, such as microphones that receive audio input and speakers that output sound.

The electronic device 104 may include one or more processors 204 that provide the processing capability required to execute the operating system, applications, and other functions of the electronic device 104. The one or more processors 204 may include general and special purpose microprocessors and/or a combination thereof. The processor 204 also may include on board memory for caching purposes and may be connected to a data bus 210 so that it can provide instructions to the other devices connected to the data bus 210.

The electronic device 104 may also include storage memory 218 for storing data required for the operation of the processor 204 as well as other data required by the electronic device 104. For example, the storage memory 218 may store the firmware for the electronic device 104 usable by the one or more processors 204, such as an operating system, other programs that enable various functions of the electronic device 104, GUI functions, and/or processor functions. The storage memory 218 may also store data files such as the near real-time media on demand application 220 and photos or videos, etc.

The electronic device 104 may also include one or more network devices 232 for receiving and transmitting information over one or more communications channels. As such, the network device 232 may include one or more network interface cards (NIC) or a network controller. In some embodiments, the network device 232 may include a local area network (LAN) interface for connecting to a wired Ethernet-based network and/or a wireless LAN, such as an IEEE 802.11x wireless network (i.e., WiFi). In certain embodiments, the LAN interface may be used to receive information, such as the service set identifier (SSID), channel, and encryption key, used to connect to the LAN.

The network device 232 also may include a wide area network (WAN) interface that permits connection to the Internet via a cellular communications network. The network device 232 may also include a personal area network (PAN) interface for connecting to a PAN such as a Bluetooth® network, an IEEE 802.15.4 (ZigBee) network, or an ultra wideband (UWB) network. The network device 232 may interact with an antenna to transmit and receive radio frequency signals of the network. The network device 232 may include any number and combination of network interfaces.

The electronic device 104 may also include a positioning device 236 used to determine geographical position. The positioning device 236 may utilize the global positioning system (GPS) or a regional or site-wide positioning system that uses cell tower positioning technology or WiFi technology, for example. The positioning device 236 may output location information that is send to, shared with, or otherwise made available to the near real-time media on demand service 130 or an affiliated entity, such as a vendor. In some embodiments, the location information includes latitudinal and longitudinal coordinates.

According to some embodiments, the electronic device 104 includes a built-in camera 224. The camera 224 may be used as part of the overall system to provide the near real-time photos and videos upon receiving a request. For example, the camera 224 may be used to capture a photo or video, which then may be processed by application 220 running the electronic device 104, which generates a response message that includes the photo or video, and location and time information.

As noted, the near real-time media on demand application 220 is included in the electronic device 104. In some embodiments, the near real-time media on demand application 220 communicates with, is controlled by, controls, and/or is partially and/or entirely integrated with other components of the electronic device. For example, in some embodiments, the near real-time media on demand application 220 is stored in the memory 218 and executed by the processor 204. In some embodiments, the near real-time media on demand application 220 is an application that a user can download and install on the electronic device 104. For example, the near real-time media on demand application 220 may be downloaded from the near real-time media on demand service 130 or from any third-party service that makes applications available for download, such as Apple®, Google®, and/or Amazon®.

In some embodiments, the near real-time media on demand application 220 may receive user input via the electronic device's tactile input controls, including switches, keys, buttons, touch sensitive buttons, etc. The near real-time media on demand application 220 may also receive user input via the touchscreen 212 and/or the microphone of the electronic device 104.

In some embodiments, the network device 232 is an interface that is partially or entirely integrated with the near real-time media on demand application 220, and can be configured to manage communications between the near real-time media on demand application 220 and any of the components of the near real-time media on demand service 130. For example, the near real-time media on demand application 220 can control and/or obtain geo-location data from the positioning device 236 and/or image data from the camera 224 of the electronic device 104. The near real-time media on demand application 220 can process said geo-location data and/or image data for its own purposes and/or send all or some of said data, either pre- or post-processed, to the near real-time media on demand service 130.

The electronic device 104 can also include a user interface 234. In some embodiments, the user interface 234 is a graphical user interface displayed to a user via the display 208. It should be appreciated that the user interface 234 may be controlled entirely or partially by the near real-time media on demand application 220. The near real-time media on demand application 220 can receive user input and it can output information via the user interface 234. For example, the near real-time media on demand application 220 may receive information from the user via the touchscreen 212, from memory 218, from the positioning device 236, from the camera 224, from the near real-time media on demand service 130, and/or any other component of environment 100 and process said information and configure content to present to the user via the user interface 234. Examples of such content are described herein.

Referring again to FIG. 1, the network 114 may include any appropriate network, including an intranet, the Internet, a cellular network, a wireless local area network, a local area network, a wide area network, a wireless data network, or any other such network or combination thereof. Components utilized for such a system may depend at least in part upon the type of network and/or environment selected. Protocols and components for communicating via such a network are well known and will not be discussed herein in detail. Communication over the network may be enabled by wired or wireless connections and combinations thereof.

The illustrated near real-time media on demand service 130 includes at least one server 134 and a data store 138. It should be understood that there may be several servers (e.g., application servers, web servers, etc.), layers, or other elements, processes, or components, that may be chained or otherwise configured, and that may interact to perform tasks, such as obtaining data from an appropriate data store. As used herein the term “data store” refers to any device or combination of devices capable of storing, accessing, and/or retrieving data, which may include any combination and number of data servers, databases, data storage devices, and data storage media, in any standard, distributed, or clustered environment.

According to embodiments, the server 134 is an application server that includes any appropriate hardware and software for integrating with the data store as needed to execute aspects of one or more applications for the electronic device 104, and may even handle a majority of the data access and business logic for an application. For example, the server 134 can be an application server that provides access control services in cooperation with the data store 138, and that is able to generate content such as text, graphics, audio, and/or video to be transferred to the user, which may be served to the user by an application on the electronic device 104 in the form of HTML, XML, or another appropriate structured language.

The data store 138 is operable, through logic associated therewith, to receive instructions from the server 134, and obtain, update, or otherwise process data in response thereto. In one example, a user might submit a request for near real-time images of a particular location. In this case, the server 134 might access user information stored in the data store 138 to determine if any active user are currently at that location, obtain contact information and preferences for those active users, and compose and transmit request message(s) according. In some embodiments, the server 134 accesses an image library of the data store 138 to locate any stored images that correspond to the requested location.

In some embodiments, the data store 138 includes user information, such as (1) user or user account identifier; (2) information indicating whether the user is active; (3) information relating to the user's location, such as longitude and latitude coordinates; (4) device information and/or device capability information (e.g., high resolution camera could be prioritized); (5) personal information about the user, such as age, gender, phone numbers, email addresses, social network memberships, payment information (credit card or bank account information and billing address), login identifier, password, and the like; (6) user library of cloud-stored photos, videos and other media the user has shared with others or received from others; (7) participation preferences including “do not disturb” times and locations as well as “active” time and locations when the user may wish to be promoted as a contributor of media.

User information may be obtained through various mechanisms. Users may expressly input and provide the user information through an application running on the electronic device 104. For example, an application may enable a user to create and manage a user profile or account that is incorporated into the user information data store 138. The user information may be obtained from a database of recorded historical participation.

The server 134 may include an operating system that provides executable program instructions for the general administration and operation of the server, and it may further include a computer-readable medium storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

The environment 100 in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 1. Thus, the depiction of the environment 100 in FIG. 1 should be taken as being illustrative in nature, and not limiting to the scope of the disclosure.

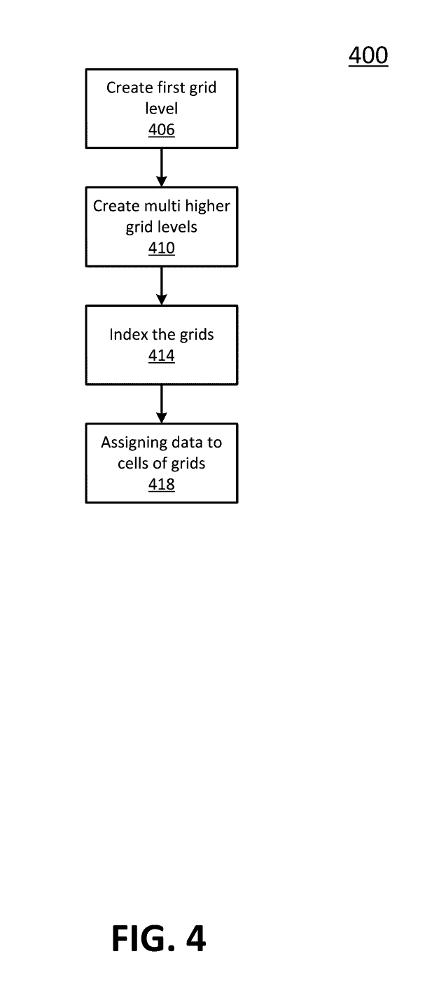

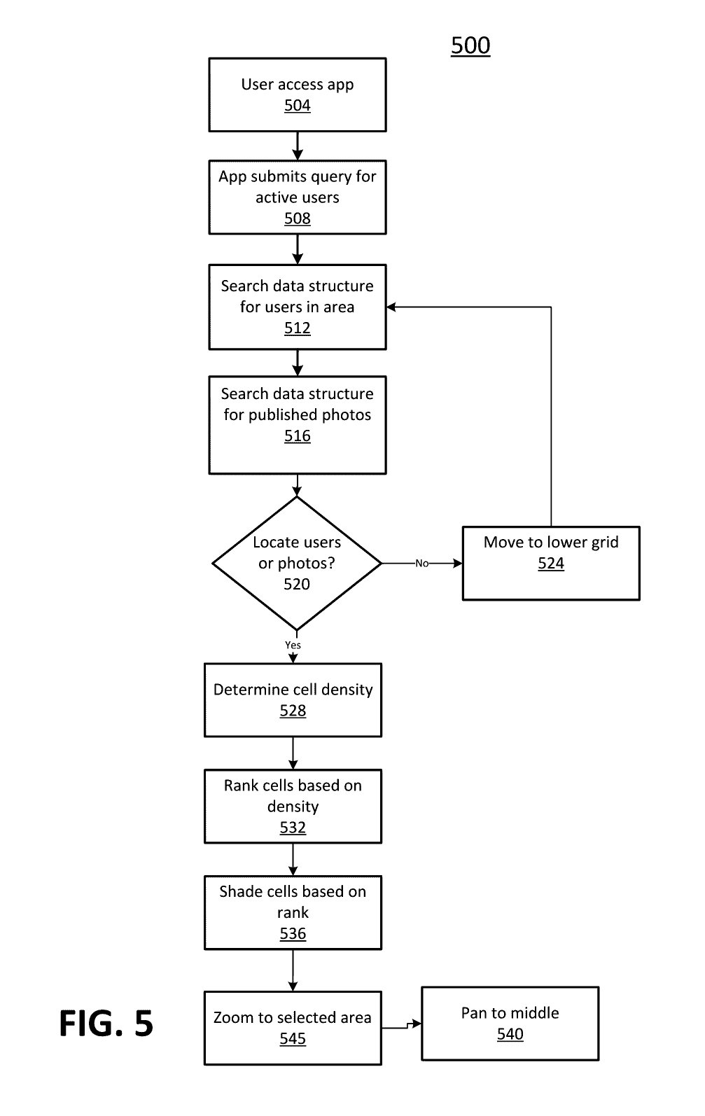

FIGS. 4 and 5 illustrate example processes 400 and 500 related to various aspects of providing near real-time media on demand, according to an embodiment. Some or all of these processes (or any other processes described herein, or variations and/or combinations thereof) may be performed under the control of one or more computer systems configured with executable instructions and may be implemented as code (e.g., executable instructions, one or more computer programs, or one or more applications) executing collectively on one or more processors, by hardware, or combinations thereof. The code may be stored on a computer-readable storage medium, for example, in the form of a computer program comprising a plurality of instructions executable by one or more processors. The computer-readable storage medium may be non-transitory. The one or more computer systems may be, as an example, one or more computer systems in the environment 100 of FIG. 1, including the electronic device 104 and/or the near real-time on demand service 130 as described in FIGS. 1-2, respectively.

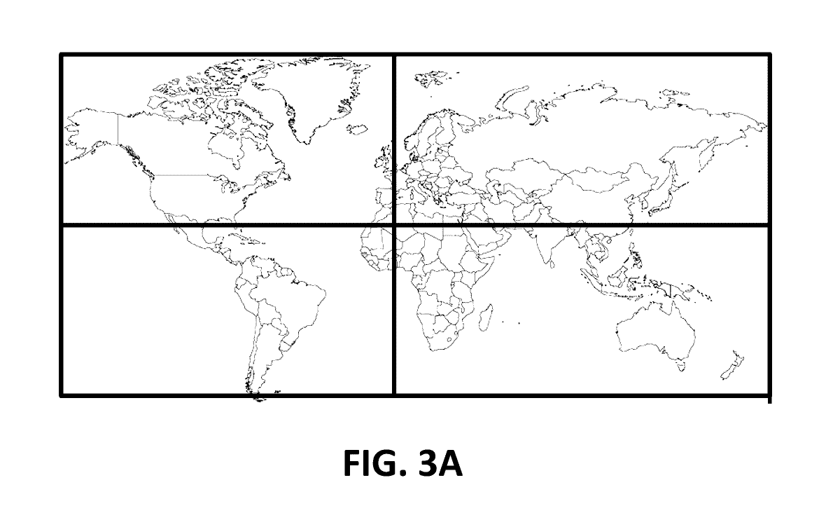

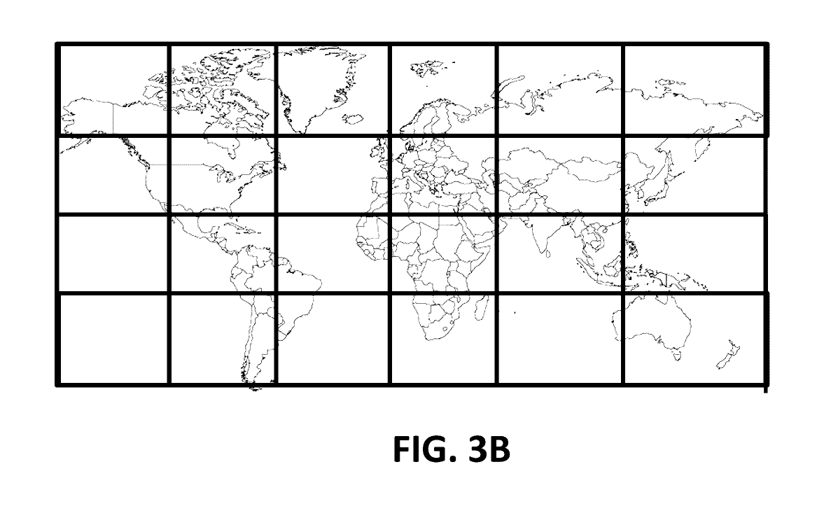

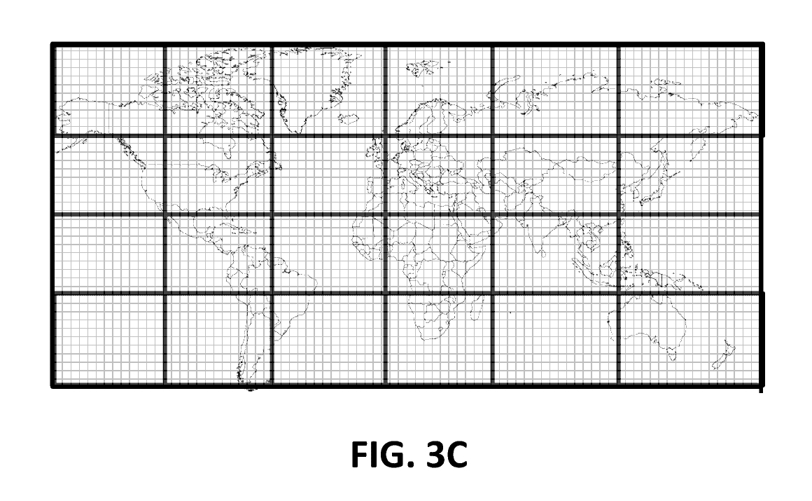

FIG. 4 provides an example process 400 for creating a hierarchical data structure, according to an embodiment. In some embodiments, the hierarchical data structure that organizes user information (e.g., profile, messages, social connections and relationships, videos, photos, and other media) according geo-location. FIGS. 3A-3C illustrate an example hierarchical data structure 300. As shown, hierarchical data structure 300 includes overlapping grids that divide the surface of Earth into cells. Each grid is a two-dimensional layer of same-sized rectangular cells, arranged relative to latitudinal and longitudinal coordinates. In some embodiments, the grid at the deepest level within the hierarchical data structure has the smallest cells (FIG. 3C), and the grid at the highest level has the largest cells (FIG. 3A). Cell sizes progressively increase from the deeper levels to the higher levels. A unique index is assigned to each cell of each grid of the hierarchical data structure 300.

As shown at 406, process 400 for creating a hierarchical data structure (e.g., 300) generally begins with creating a first grid having same-sized rectangular squares that divide up the surface of the Earth. In some embodiments, the first grid is the highest and has the largest cells (e.g., FIG. 3A). The first grid is located at the first level of the hierarchical data structure. At 410, process 400 involves creating a second, deeper level grid (e.g., FIG. 3B) having same-sized rectangular cells, which are smaller than the cells of the first layer. In some embodiments, the second grid is created by refining the cells of the first grid. For example, a one-to-two or one-to-four refinement could be used, such that the cells of the second level are one-half or one-quarter the size of the cells of the first level. At 416, process 400 involves creating one or more progressively deeper girds (e.g., FIG. 3C) with progressively smaller cells. In some embodiments, the deepest grid with the smallest cells (e.g., FIG. 3C) is created first at 406, and then the higher level grids are progressively created thereafter (e.g., FIG. 3B and then FIG. 3A).

At 414, process 400 involves indexing each of the grids based at least in part on the latitudinal and longitudinal coordinates of the individual cells. In some embodiments, the indexing is also based on the level of the grid within the hierarchical data structure. Thus, each cell of the hierarchical data structure is assigned a unique index that maps to the geo-location (e.g., lat/long coordinates) of the cell as well as the level of the cell within the hierarchy. The geo-location information could include a point (e.g., centroid) within the cell and an area of the cell that surrounds that point, for example. In some embodiments, the geo-location of the cells of the first level is determined based on their latitude and longitude and/or relative distance to each other. Location of the cells of the higher levels can be determined the same way, and/or based on their relative location to the cells of the first level (e.g., hierarchy-based indexing). At 418, process 400 involves assigning users to the cells of the hierarchical data structure based on location information (e.g., lat/long) associated with that user. In some embodiments, an active user's identifier is dynamically mapped to all cells that overlap that user's current location.

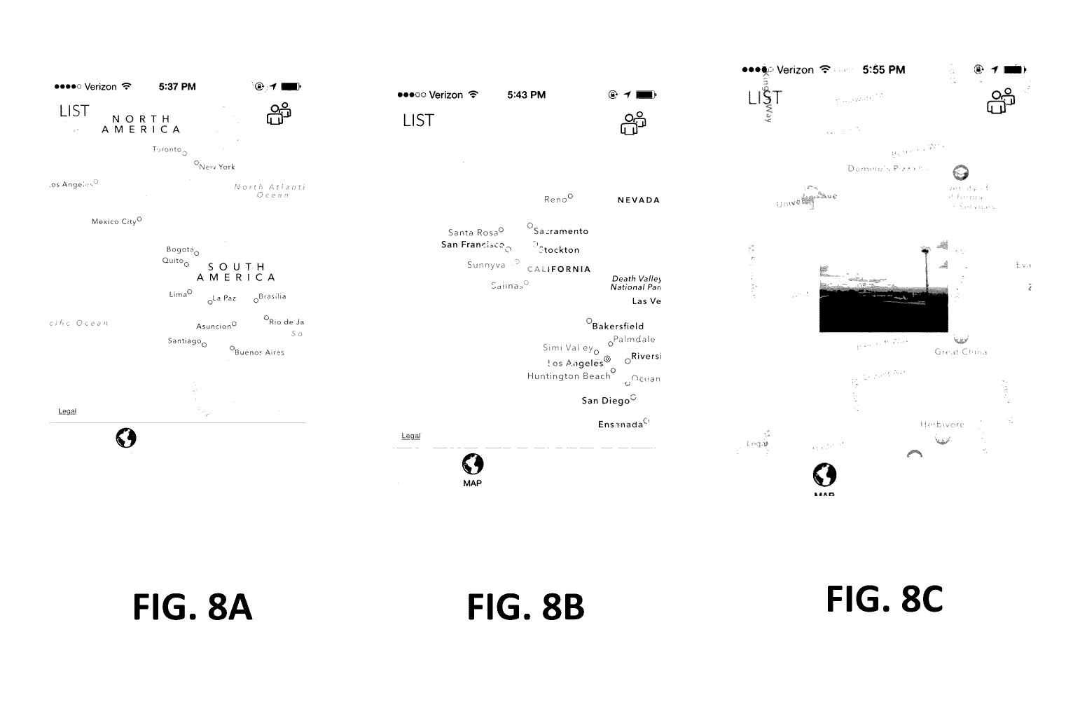

FIG. 5 shows a process 500 for using the hieratical data structure to process queries relating to user request to obtain near real-time photos, video, or other media from other uses located anywhere in the world. At 504, the user 108 accesses the near real-time media on demand application 220 running on the client device 104 and navigates and zooms to an area of the map that is of interest to the user. FIG. 8A provides an example screen shot of an area of the map to which the user navigated. At 508, the near real-time media on demand application 220 queries the near real-time media on demand service 130 for all active users currently located in the cells of the hierarchical data structure that correspond to that area of the map. In some embodiments, the query specifies specific cells of a specific level. To do so, for example, the near real-time media on demand application 220 determines which grid level of the hierarchical data structure corresponds to the zoom level, and which cells of that grid overlay the area of the map that the user is viewing. In one example, if the user has zoomed out to the furthest zoom level, and is currently viewing the entire world, the application determines that the zoom level corresponds to the highest grid level of the hierarchical data structure (e.g., FIG. 3A), and that all cells of that grid overlay the area that the user is viewing. Thus, in this example, the query specifies all cells of the highest level (e.g., the level with the biggest and least number of cells). In another example, if the user has zoomed in on a particular region of the world, such as a continent, country, or city, the application determines which grid level of the hierarchical data structure corresponds to that zoom level and which cells of that grid level overlay the particular region. Thus, in some embodiments, the process 500, at 508 involves querying the near real-time media on demand service 130 to return all active users located in specific grid cells of a specific grid level of the hierarchical data structure.

At 512, the near real-time media on demand service 130 searches the data store 138 for active users whose current location corresponds to the identified cells. For example, the near real-time media on demand service searches data associated with each of the identified cells, and locates within that data user identifiers of users currently located within that cell. At 516, the near real-time media on demand service 130 identifies any published photos or other previously published media whose identifier corresponds with the identified cells. At 520, if no users or published photos were identified in the cells of the specified layer of the hierarchical data structure, process 500 it proceeds to the next lowest layer and determines which cells of that layer that overlay the area that the user is currently viewing, as indicated at 524. Process 500 then returns to 512 and 516 to determine whether any active users or published photos or other media are located in those lower level cells. Process 500 continues to loop between 512 and 520 until it identifies active users or published photos.

Referring against to 520, if any users or published photos were identified, the process 500 proceeds to 528, where it determines the respective density of the specified cells. For example, the service determines which of the cells currently has the most activity. In some embodiments, the near real-time media on demand service 130 determines density based on number of users (x) and photos (y). In some embodiments, one user is equal to ten, or so, published photos (e.g., density=x+y/10). This is because, in these embodiments, density measures activity, and current users generate more activity than previously published photos. FIG. 8C illustrates a screenshot, according to one embodiment, of an example previously published photo.

At 532, process 500 ranks the cells according to density. At 536, process 500 shades the cells based on their relative density, so as to create a heat map that show which cells currently have the most activity. Users of the near real-time media on demand application 220 may find those cells more interesting. In some embodiments, the densest cell is shaded such that is opaque, or almost opaque, and cells with no activity are completely transparent. All other cells are progressively shaded from opaque to transparent. In some embodiments, alpha blending is used to determine the distance between shading intervals. FIGS. 8A-C show example screen shots of shaded cells. In some embodiments, the density values of each cell are reviewed to find highest, Dmax. That becomes the divisor so heat map cell density is then density/Dmax. In some embodiments, the density this then clipped to floor value of 0.3 and ceiling 0.7 in the alpha values.

At 540, process 500 executes a targeted pan operation. For example, the near real-time media on demand application 220 determines, and pans to, a central location of the area based on distance from the users and published photos and other media identified at that level. In some embodiments, denser cells are weighted more heavily and therefore are more likely to be closer to the center location. At 545, responsive to a user selection of a cell or another area of the map, the near real-time media on demand application 220 zooms to the selected cell or area. For example, FIGS. 8A and 8B illustrate the application 220 zooming from FIG. 8A to 8B in response to a user selection. In some embodiments, process 500 returns to 520. In other embodiments, process 500 returns to 508 so as to query fresh data that accounts for real-time movement and/or because the new zoom location includes area that were excluded from the previous query. As illustrated in FIG. 8C, once the user has zoomed all the way to the deepest level, the user is presented with icons that represent users currently active in that area, as well as icons that represent previously published photos, videos, and other media. Responsive to the user selection of an icon of an active user, and the application 220 presents them with a user interface for sending the selected user a request to send a photo, video, or other media. Also, responsive to the user selection of an icon of a previously published photo, video, or other media, the application 220 displays that selected photo, video, or other media (e.g., FIG. 8C).

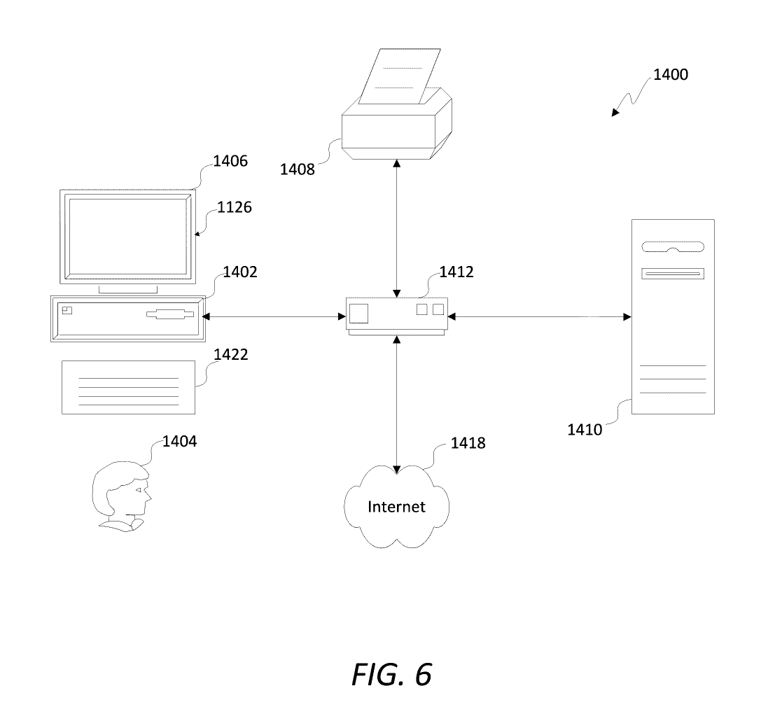

FIG. 6 is an example environment 1400 in which embodiments may be implemented. The environment 1400 includes a computer 1426, a network router 1412, a printer 1408, and a server 1410, interconnected by a network 1418, such as the Internet, wide area network, local area network, etc. The computer 1426 includes a monitor 1406, a processor 1402, and keyboard 1422. The computer 1426 can be, for example, a laptop computer, desktop computer, handheld computer, and electronic device, such as electronic device 104, a mainframe computer, etc. According to embodiments, users can input commands into the computer 1426 using various input devices, such as a touch screen, a mouse, the keyboard 1422, track ball, etc.

The server 1410 may, for example, be used to store additional software programs and data. In one embodiment, software implementing the systems, methods, and processes described herein can be stored on a storage medium in the server 1410. Thus, the software can be run from the storage medium in the server 1410. In another embodiment, software implementing the systems, methods, and processes described herein can be stored on a storage medium in the computer 1426. Thus, the software can be run from the storage medium in the computer system 1426. Therefore, in this embodiment, the software can be used whether or not computer 1426 is connected to network router 1412. It should be appreciated that the printer 1408 may be connected directly to computer 1426, rather than via the router 1412.

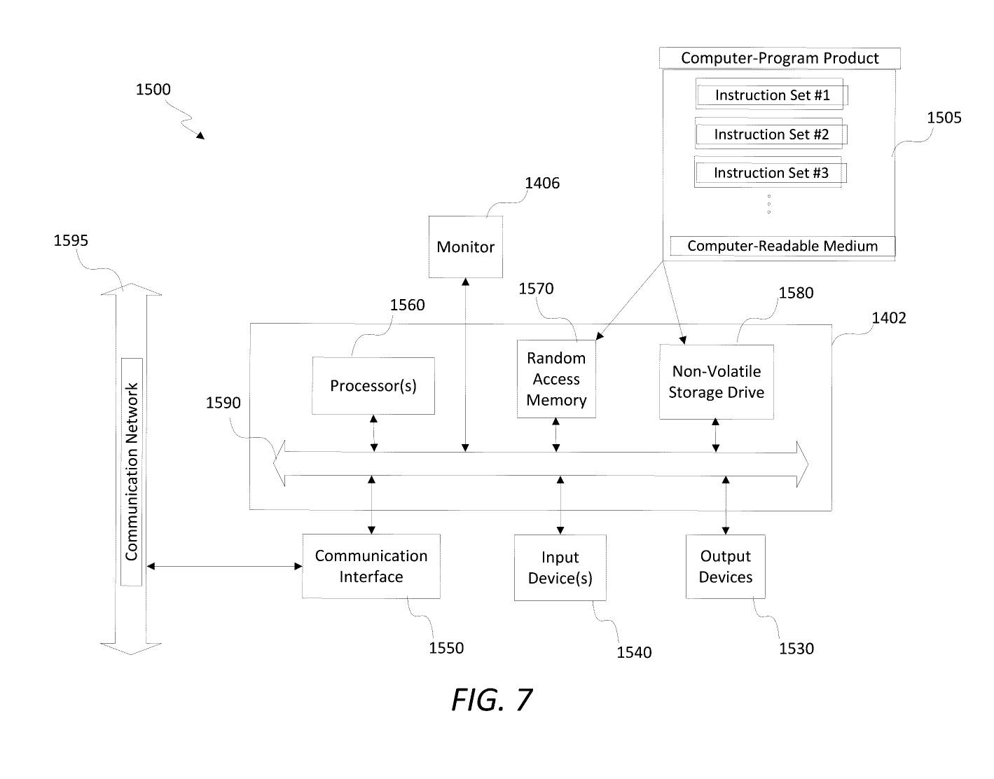

As illustrated in FIG. 7, an embodiment of a special-purpose computer system 1500 is shown. For example, the on-demand shipping manager 154 and components thereof may be a special-purpose computer system 1500. The above methods may be implemented by computer-program products that direct a computer system to perform the actions of the above-described processes and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer 1426, it is transformed into the special-purpose computer system 1500.

Special-purpose computer system 1500 comprises a computer 1502 having connected thereto user output device(s) 1506 (e.g., monitor), user input device(s) 1510 (e.g., keyboard, mouse, track ball, touch screen), communication interface 1516, and/or a computer-program product 1520 stored in a tangible computer-readable memory. The computer-program product 1520 directs computer system 1500 to perform the above-described methods and processes. The computer 1502 may include one or more processors 1526 that communicate with a number of peripheral devices via a bus subsystem 1530. These peripheral devices may include the user output device(s) 1506, the user input device(s) 1510, the communications interface 1516, and a storage subsystem, such as random access memory (RAM) 1536 and non-volatile storage drive 1540 (e.g., disk drive, optical drive, solid state drive), which are forms of tangible computer-readable memory.

The computer-program product 1520 may be stored in the non-volatile storage drive 1540 or another computer-readable medium accessible to the computer 1502 and loaded into memory 1536. Each processor 1526 may comprise a microprocessor, such as a microprocessor from Intel® or Advanced Micro Devices, Inc.®, or the like. To support computer-program product 1505, the computer 1502 runs an operating system that handles the communications of product 1520 with the above-noted components, as well as the communications between the above-noted components in support of the computer-program product 1520. Example operating systems include Windows® or the like from Microsoft Corporation, OS X® from Apple, Solaris® from Sun Microsystems, LINUX, UNIX, and the like.

User input devices 1510 include all possible types of devices and mechanisms to input information to the computer 1502. These may include a keyboard, a keypad, a mouse, a scanner, a digital drawing pad, a touch screen incorporated into the display, audio input devices such as voice recognition systems, microphones. The user input devices 1510 typically allow a user to select objects, icons, text and the like that appear on a monitor via a command such as a click of a button or the like. The user output devices 1530 include all possible types of devices and mechanisms to output information from computer 1402. These may include a display, a monitor, printers, non-visual displays such as audio output devices, etc.

The communications interface 1516 provides an interface to other communication networks and devices and may serve as an interface to receive data from and transmit data to other systems, wide area networks (WANs) and/or the Internet. Embodiments of communications interface 1516 include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1516 may be coupled to a computer network, to a FireWire® bus, or the like. In other embodiments, the communications interface 1516 may be physically integrated on a motherboard of the computer 1502, and/or may be a software program, or the like.

The memory 1536 and non-volatile storage drive 1540 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, barcodes, semiconductor memories such as flash memories, read-only-memories (ROMs), battery-backed volatile memories, networked storage devices, and the like. The memory 1536 and the non-volatile storage drive 1540 may be configured to store the basic programming and data constructs that provide the functionality of various embodiments of the present invention, as described above.

Software instruction sets that provide the functionality of the present invention may be stored in the memory 1536 and non-volatile storage drive 1540. These instruction sets or code may be executed by the processor(s) 1526. The memory 1536 and the non-volatile storage drive 1540 may also provide a repository to store data and data structures used in accordance with the present invention. The memory 1536 and the non-volatile storage drive 1540 may include a number of memories including a main RAM to store of instructions and data during program execution and a ROM in which fixed instructions are stored. The memory 1536 and the non-volatile storage drive 1540 may include a file storage subsystem providing persistent (non-volatile) storage of program and/or data files. The memory 1536 and the non-volatile storage drive 1540 may also include removable storage systems, such as removable flash memory.

The bus subsystem 1530 provides a mechanism to allow the various components and subsystems of computer 1502 to communicate with each other as intended. Although bus subsystem 1530 is shown schematically as a single bus, alternative embodiments of the bus subsystem may utilize multiple busses or communication paths within the computer 1502.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including ROM, RAM, magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

What is claimed is:

1. A method for creating a hierarchical data structure, comprising
creating a first grid having same-sized rectangular squares that divide up the surface of the Earth, wherein the first grid is located at a first level of the hierarchical data structure
creating a second grid having same-sized rectangular cells, wherein the second grid is located at a second, deeper level of the hierarchical data structure, wherein the cells of the second grid are smaller than the cells of the first grid.

2. A method according to claim 1, wherein the second grid is created by refining the cells of the first grid.
